(19) United States
(12) Patent Application Publication
(10) Pub. No.: US 2013/0046271 A1
(43) Pub. Date: Feb. 21, 2013

(54) FILLING

(71) Applicants: Michel Pittet, Aumont (CH); Caroline Ansermet, Denges (CH); Bastien Ecabert, Bussigny (CH); Cedric Berchier, La Tour-de-Peilz (CH)

(72) Inventors: Michel Pittet, Aumont (CH); Caroline Ansermet, Denges (CH); Bastien Ecabert, Bussigny (CH); Cedric Berchier, La Tour-de-Peilz (CH)

(73) Assignee: B. Braun Melsungen AG, Melsungen (DE)

(21) Appl. No.: 13/642,129

(22) PCT Filed: May 2, 2011
(86) PCT No.: PCT/EP11/56957

§ 371 Date: Oct. 19, 2012

(30) Foreign Application Priority Data
May 10, 2010 (EP) 10 162 375.9

(51) Int. Cl. A61J 1/10; B65B 3/02

(52) U.S. Cl. 604/410; 53/456

(57) ABSTRACT

The present invention refers to a flexible multiple chamber bag for storing medical products comprising two or more chambers.

A flexible multiple chamber bag (10) made by circumferentially welding two foils being non peelable and furthermore containing peelable and non-peelable welds (4,5,6) within the circumference weld (7) for the separate storing of medical products in separate chambers (1,2,3), containing a hanger flap (11) extending from the top end of said bag (10) and a single medical port system (9) welded within the lower end of said circumferential weld (7) of said bag (10) characterized in that one side end but different from the top end and the lower end of said circumferential weld (7) of said bag (10) contains a number of non-welded frustoconical-shaped interruptions (12,13,14) between said foils, each of said interruptions (12,13,14) respectively being connected to a different chamber (1 or 2 or 3) allowing the temporarily or permanent introduction of an appropriate filling tube (22,23,24) into each of said interruptions (12,13,14).

The present invention refers to a flexible multiple chamber bag for storing medical products comprising two or more chambers.

In the pharmaceutical industry and especially in the field of perfusion solutions, impermeable flexible bags are extensively used. Such bags or containers are prepared from polymerized materials which have to meet a wide variety of requirements. Thus, in particular, gas and vapor tightness, transparency, printability and inertness towards the substances they contain, are of essential importance. The substances contained in the containers or bags essentially consist of salts and solutions thereof, carbohydrates, amino acids and lipids. They are usually employed in multicompartment bags, the individual compartments or chambers being filled with different components.

DE 44 10 876 A1 relates to a multicompartment bag made of a polymeric material, who's bag compartments are formed by welds in the peripheral (circumferential) region and by at least one weld in the intercompartment region, the welds being formed from the polymeric materials facing the compartments. The circumferential weld contains several ports for filling the respective chambers in addition to a port for entering the container. Nothing is disclosed about the filling of the bag.

EP 0 295 204 B1 describes a container for medical use, in particular a container for infusions consisting of an envelope made of a flexible, homogeneous, polymerized material which is divided into three compartments, separated from each other by leaktight welds of the envelope material and each of said compartments is provided with an occluded passage which can be opened deliberately to enable the contents of the part of the interior space to flow into another one, wherein the container has two adjacent compartments (3,4) of the interior space within the upper portion thereof and one compartment (5) in its lower part within the lower portion thereof and is intended for taking up and mixing subsequently lipids, amino acids, and sugars just before the use thereof, wherein each compartment is provided with one occludable opening in order to supply the compound through said opening or to discharge the contents thereof through said opening outwards, and wherein the material of the envelope is chemically and biologically inert against any envisaged compound and the mixtures thereof. The upper chambers (3,4) are filled by the use of permanent ports (7,8), welded within the circumferential weld of the container. Due to the presence of the permanent ports (7,8) there is a potential risk of an unintended opening of the bag.

DE 94 01 288 U1 pertains a multichamber bag having at least two chambers being arranged one upon another during the mixing stage and being surrounded by an exterior boundary, said chambers being separated from another by at least one bar and forming an upper chamber and a mixing chamber, said bag having at least one connecting device being arranged within the bar and being closed by a locking device which is to be opened, said connecting device providing a flow connection between the chambers after being opened, said bag having at least one hang up opening at the upper boundary region and a discharge device being arranged at the mixing chamber as well as a second discharge device being opposite to said former discharge device and being arranged in the circumferential region of the mixing chamber. Nothing is disclosed with respect to the filling of said bag.

DE 196 05 357 A describes a flexible plastic container 1 for the spatially separated storage and, optionally selective sterilization of the ingredients of preparations for parenteral or enteral use, comprising at least four compartments, 2,3,4, and 5, and, optionally, a compartment 6 being suited for taking up trace elements within compartment 2, carbohydrates within compartment 3, fats within compartment 4, and amino acid solutions within compartment 5, and, optionally, electrolytes and/or vitamins within compartment 6, said container having one of the closable fill in openings 7, 8, 9 and 10, and, optionally, 11, each; one discharge opening 12 for administering the mixture of ingredients of the preparations for parenteral or enteral use; connecting means 13, 13′, 14,14′ and 15, 15′ and, optionally, 16, 16′ which can be opened sterilely from the outside, by which flow connections between the compartments 2,3,4 and 5 and, optionally 6, respectively, can be provided; wherein the proportions by volume of compartments 2,3,4 and 5 and, optionally 6 are selected such that in the working position as resulting from suspending by hang up means 17 a complete mixture of all ingredients within compartment 5 is possible by opening the connecting means 13,13′, 14, 14′ and 15, 15′, and optionally 16, 16′; the proportion by volume of compartment 2 to compartment 3 is selected such that in the working position as resulting from suspending by hang up means 17 a complete mixture of the ingredients of compartments 2 and 3 within compartment 3 is possible by opening the connecting means 13, and, optionally, the proportion by volume of compartment 4 to compartment 6 is selected such that in the working position as resulting from suspending by hang up means 17 a complete mixture of the ingredients of compartments 4 and 6 within compartment 4 is possible by opening the connecting means 16, 16′. Due to the presence of the permanent filling ports (7,8,9,10,11) there is a high risk of an unintended damage of the bag. Furthermore, the handling of the bag is handicapped.

EP 1 011 605 B2 relates to a flexible plastic container (1) for the spatially separated storage and, optionally, selective sterilization of the ingredients of preparations of parenteral or enteral use, consisting of only three compartments, a first compartment (3, a second compartment (4) and a third compartment (5), said compartments being separated from each other by means of leaktight welds of the envelope material, said compartments having one closable fill in opening (7), (8) and (9), each; connecting means (10) and (11) which are formed as peelable heat-sealed welds which can be opened sterilely from the outsides, by which respective flow connections between compartments (3), (4) and (5) are selected such that in the working position as resulting from suspending by the hang up means (12) a rapid and complete mixture of all ingredients within the third compartment (5) is possible by opening the connecting means (10) and (11), characterized in that the first compartment (3) contains carbohydrates, the second compartment (4) lipid and the third compartment (5) amino acids. The same disadvantage applies as mentioned with respect to DE 196 05 357 A1.

WO 2007/037793 A1 relates to a multiple chamber container for separately storing components of a parenteral nutritional formulation. The multiple chamber container may include frangible barriers, preferably peelable seals separating the chambers from each other. The container preferably facilitates the selective activation of the peelable seals to permit the admixing of less than all the separately stored components. The container may include a chamber positioned at each other of the opposite lateral ends of the container and at least one additional chamber between the lateral chambers. The at least one additional chamber may have a longitudinal length substantially less than the longitudinal length of at least one of the lateral chambers. This configuration allows for selective opening of the seals since when rolling the container from the top avoids pressurizing the at least one additional chamber and inadvertent activation of a seal. The longitudinal length of the at least one additional chamber may be from about two-thirds to about three-fourths the longitudinal length of at least one of the lateral chambers. Alternatively, the container may include a hanger flap extending from a top end of the container towards the bottom end of substantially greater distance relative to the at least one additional chamber than the lateral chambers. The container includes several ports at the bottom end constructed as an additive port to allow the addition of materials and/or can be constructed as administration ports. The same disadvantages as mentioned above apply.

EP 1 773 277 B1 relates to a container for storage a pharmaceutical agent made of a flexible polymeric film wherein the container comprises at least one peelable seal comprising at least two substantially straight sections (7,8), which are connected by a curved rupture zone (5), the curved rupture zone (5) of the peelable seal being formed as an arc of a circle having a central angle of at least 60° and being curved over its whole length between the straight sections (7,8), characterized in that the curved rupture zone (5) is formed as an arc of a circle with a radius of 5 to 75 mm, wherein the radius is measured from the central point of the circle to a point of the outer edge of the seal, wherein the outer edge is the edge that is more dislodged from the central point than the inner edge, and that the substantially straight sections (7,8) of the peelable seal form an angle of 150° to 180°. The same disadvantage, as mentioned with respect to WO 2007/037793 A1 apply.

WO 97/37628 relates to an improved container for parenteral fluids. Said publication in particular discloses a flexible transparent container for improved storage of oxygen sensitive parenterally administrable agents comprising an inner, primary container enclosed in a substantially oxygen impermeable outer envelope with an oxygen absorber, capable of consuming essentially all residual oxygen after the outer envelope is sealed, and for sufficient period also the oxygen penetrating said envelope. The inner container is made of a polypropylene containing flexible polymeric material compatible with lipophilic agents capable of forming both permanent and peelable seals, while the envelope is made of a substantially water impermeable flexible multilayered polymeric material comprising a first outer substantially water impermeable polymeric film with oxygen barrier forming capacity, assembled with a second, inner polymeric film with a supplementary oxygen barrier forming capacity. The container essentially maintains its characteristics after being subjected to sterilization by steam or radiation. Nothing is disclosed about filling the container.

Thus, it is the aim of the present invention to simplify the filling and handling of a flexible multiple chamber bag for storing medical products and in particular to improve the use thereof by the nurse.

The above objects of the invention are met in a first embodiment of the invention by a flexible multiple chamber bag 10 made by circumferentially welding two foils being non peelable and furthermore containing peelable and non-peelable welds 4,5,6 within the circumference weld 7 for the separate storing of medical products in separate chambers 1,2,3, containing a hanger flap 11 extending from the top end of said bag 10 and a single medical port system 9 welded within the lower end of said circumferential weld 7 of said bag 10 characterized in that one side end but different from the top end and the lower end of said circumferential weld 7 of said bag 10 contains a number of non-welded frustoconical-shaped interruptions 12,13,14 between said foils, each of said interruptions 12,13,14 respectively being connected to a different chamber 1 or 2 or 3 allowing the temporarily or permanent introduction of an appropriate filling tube 22,23,24 into each of said interruptions 12,13,14 wherein the opening angle from the inner side of the weld to the outer side of the weld of said frustoconical interruptions (12,13,14) is adjusted by welding and encompasses a solid angle of 15° to 60°.

Due to the specific structure of the circumferential weld of a multiple chamber bag, the object of the invention as outlined above is met.

FIG. 1 in detail shows a flexible multiple chamber bag 10 according to the present invention, which is intended for storing medical products therein at a later stage.

The multiple chamber bag according to the present invention in FIG. 1 contains three adjacent chambers 1,2,3 although additional chambers may be added without disturbing the geometry of the welded seams 4, 5 and 6.

An upper chamber 2 and a lower chamber 3 are separated by a welded seam 4, 6 which as such extend from the right to the left circumferential weld of the multiple chamber bag. However, said weld 4,6 although terminating essentially in a right angle at the circumferential weld 7 does not extend as a linear weld, it contains a non-peelable part 4 and a peelable part 6 which together form a wing.

The seams 5 and 6 are peelable when applying pressure on the bag 10 independent from the technique of the nurse applying said pressure by rolling the multiple chamber bag or by applying pressure by hand.

In an preferred embodiment, the multichamber bag according to the present invention is made of a flexible polymeric film having a region with a higher melting point designated as its outside and having a region with a lower melting point designated as its sealing inside, which can be sealed together by means of conventional welding tools to permanent or peelable seams. It is to be understood that the inner region is intended to face the stored components and can form both, permanent seams and different peelable seams when subjected to different welding conditions or operations. It is in particular preferred that the film is made of at least two different polymer layers wherein the inside layer is a sealant layer being capable of forming both, permanent seams and peelable seams when subjected to welding at different temperatures. Polymeric material providing said features are known from the prior art as defined above.

There is always a balance between the demands to have a peelable seam being strong enough to withstand the manufacturing process of the multichamber bag and on the other hand to be easy to open for the nurse. Flexible multichamber bags with peelable seams of low seal strength for example 5 to 10 N/30 mm can be readily opened but seams of low strength can be damaged during manufacturing or transport of the multichamber bag. For this reason, it is advantageous in accordance with the prior art to manufacture peelable seams with a seal strength of at least 30 N/30 mm and more preferably with a seal strength of 40 N/30 mm.

The extension of said welded seams 5 and 6 preferably has the shape of an inverse letter “V” with increasing angle of the lines of said “V” from the basic point 8 of said “V”. Preferably the angle of the letter “V” is increased continuously avoiding hard corners to be peeled. An appropriate “V” without said increasing angle would result in a termination of said welds 5,6 in an angle at the circumferential weld 7 of said bag of less than 90° relative to the top and of said bag 10 and thus would result in a dead volume. Thus, the wing-like appearance of the peelable seals 5 and 6 ensures the option of a complete emptying of the flexible multiple chamber bag.

The basic point 8 of said “V” is fixed due to the extension of the non-peelable seal 4 even when applying pressure on the bag 10 as being part of the non-peelable seam 4. Thus, the exact position thereof is determined by the appearance of the seams 4,5,6. Even in case the nurse puts pressure on the wrong part of the multichamber bag, its construction in any case prohibits a first incompatible mix of lipids and glucose (carbohydrate) and furthermore an administration of a high concentrated glucose solution without the admixture of the amino acids and the lipid to the patient.

A bag 10 according to the present invention comprises a hanger flap extending from the top and of said bag next to the chamber 2 in particular within the circumferential weld 7.

In FIG. 1 the interruptions 12,13,14 of the circumferential weld 7 are depicted on the right hand side of the multichamber bag 10. The interruptions 12,13,14 as depicted in FIG. 1 have a double frustoconical-shape with a minimum radius in the center of a coil when spreading the foils.

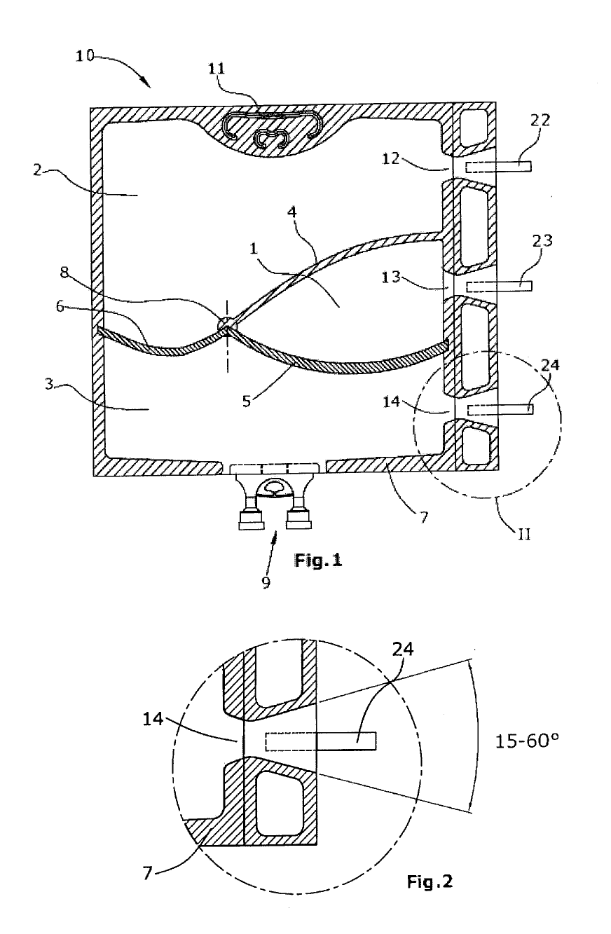

FIG. 2 is a detailed view of a preferred embodiment of the interruptions 12,13,14 showing again the double frustoconical-shape which will be apparent when opening the non-welded gap between the foils resulting in said frustoconical-shape. It goes without saying that the filling tubes 22,23, 24 have to be adapted to the minimum diameter of the frustoconical-shape. The reason for this is to provide a leak-tight insertion of the filling tubes 22,23,24 into the interruptions 12,13,14 allowing the filling of the medical products into the separate chambers.

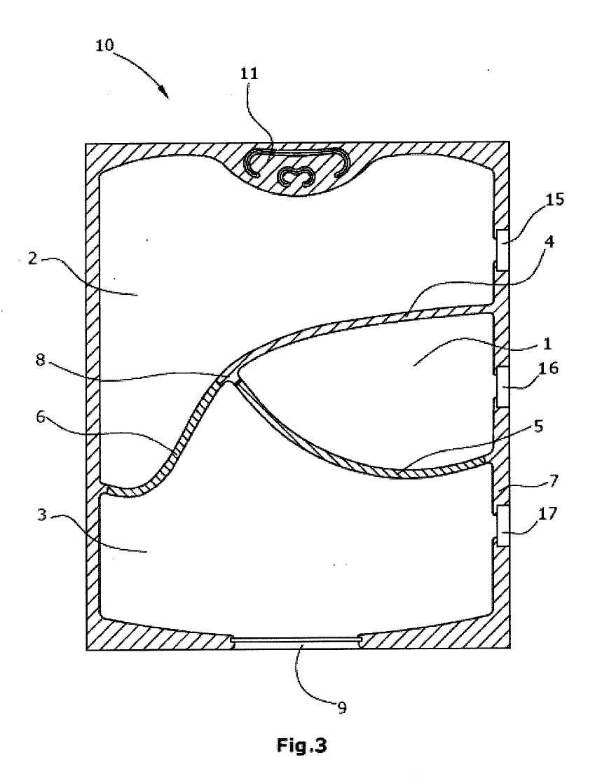

In FIG. 3 the resultant multiple chamber bag 10 is depicted. This bag 10 may be obtained by the process according to the present invention in particular by
(a) Circumferentially welding two polymer foils 7 of polymer by incorporating a single medical port system 9 at a lower end of said circumference weld 7 between said foils,
(b) Providing separate chambers 1,2,3 for the storage of medical products within said circumferential weld 7 by peelable and non-peelable welds 4,5,6,
(c) Leaving unwelded frustoconical interruptions 12,13,14 in one side end of said circumferential weld 7 in an amount corresponding to the number of chambers 1,2,3 suitable for the introduction of filling tubes 22,23,24 in said interruptions 12,13,14,
(d) Introducing said filling tubes 22,23,24 in a liquid tight connection into said interruptions 12,13,14,
(e) Filling said chambers 1,2,3 with said medical products,
(f) welding said interruptions 12,13,14 to provide a liquid tight bag 10, and
(g) Cutting off those parts of the circumferential weld 7 containing said filling tubes 22,23,24.

Conclusively, the resultant bag from a first glance does not show differences with respect to for example DE 44 10 876 A1 with respect to the absence of filling means of the bag. Nevertheless, the final resultant flexible multiple chamber bag 10 used to the administration of the medical products to the patient, shows the characteristic tight weldings 15,16,17 in the circumferential weld. These specific tight weldings 15,16,17 result to the formerly present interruption 12,13,14 and thus, in detail show a difference with respect to the above referenced prior art.

In a preferred embodiment of the present invention, the flexible multiple chamber bag 10 as well as the resultant final bag 10 contain two, three, four or more chambers 1,2,3 whereby a three or four chamber bag is in particularly preferred.

An important benefit of the present invention can be found in that a container having at least three chambers 1,2,3 has an appropriate amount of interruptions 12,13,14 or appropriate weldings 15,16,17, whereby the distance between each of said interruptions 12,13,14 of the appropriate leak-tight weldings 15,16,17 is the same. In case this equi-distant concept is transferred to bags with a different number of chambers or a different size of volume by maintaining the same distance between the interruption 12,13,14 or the weldings 15,16,17, all kind of different multiple chamber bags can be filled in one single automatic fillings machine without the necessity of adapting the machine in view of an alteration of the kind of the flexible multiple chamber bag 10. This kind of filling automatically will improve the handling for the filling operation.

In order to allow an improved introduction of the tubes 22,23,24 into the interruptions 12,13,14 the opening angle of the frustoconical-shape of the interruptions 12,13,14 has to be adapted to the diameter of the filling tubes. Thus, the opening angle in view from the inner side of the weld to the outer side of the weld of said frustoconical interruptions 12,13,14 is adjusted by welding and encompasses solid angle of 15° to 60°, in particular 20° to 45°. The specific angle allows a quick flushing and emptying of the bag with an inert gas, in particular nitrogen prior to the filling with the final content.

Once the tubes 22,23,24 are inserted in the interruptions 12,13,14, the chambers 1,2,3 may be all or separately flushed with nitrogen or another medium for sterilization prior to the filling of the chambers by injecting the liquid and/or solid pharmaceutical products.

Once the chambers 1,2,3 have been filled with the desired products the interruptions 12,13,14 are welded leak-tight followed by cutting off the outer edge containing the filling tubes 22,23,24.

In another preferred embodiment the filling tubes 22,23,24 are first removed from the interruptions 12,13,14 prior to the leak-tight welding and cutting off the outer edge. This variation in particular allows a reuse of the filling tubes.

The multichamber bag 10 according to the present invention does no longer contain any ports for the introduction of the contents to chambers 1,2,3 but only contains a medical port 9 welded to the lower and of said circumferential weld 7.

As mentioned above, the final bag 10 according to the present invention in particular contains medical products, such as solutions, emulsions, suspensions and/or dispersions suitable for parenteral or enteral nutrition of patients.

In particular, chamber 1 partially separating chamber 2 and chamber 3 contains a fat emulsion. Accordingly, the upper chamber 2 contains a carbohydrate solution and the lower chamber 3 contains an amino acid solution. The features of the bag as described above ensure a rapid mixing and complete emulsification of all contents of the container.

1. A flexible multiple chamber bag (10) made by circumferentially welding two foils being non peelable and furthermore containing peelable and non-peelable welds (4,5,6) within the circumference weld (7) for the separate storing of medical products in separate chambers (1,2,3), containing a hanger flap (11) extending from the top end of said bag (10) and a single medical port system (9) welded within the lower end of said circumferential weld (7) of said bag (10)
characterized in that
one side end being different from the top end and the lower end of said circumferential weld (7) of said bag (10) contains a number of non-welded frustoconical-shaped interruptions (12,13,14) between said foils, each of said interruptions (12,13,14) respectively being connected to a different chamber (1 or 2 or 3) allowing the temporarily or permanent introduction of an appropriate filling tube (22,23,24) into each of said interruptions (12,13,14) wherein the opening angle from the inner side of the weld to the outer side of the weld of said frustoconical interruptions (12,13,14) is adjusted by welding and encompasses a solid angle of 15° to 60°.

2. The flexible multiple chamber bag (10) according to claim 1, characterized in that it contains 2, 3, 4 or more chambers (1,2,3).

3. The flexible multiple chamber bag (10) according to claim 2, containing at least 3 chambers (1,2,3), whereby the distance between each of said interruptions (12,13,14) is the same.

4. A multitude of multiple chamber bags (10) according to claim 1, characterized in that independent from the number of chambers (1,2,3) and/or the volume of said chambers (1,2,3) the distance between each of said interruptions (12,13,14) is the same.

5. A process for the preparation and filling of a bag (10) according to claim 1, characterized by
(a) Circumferentially welding two polymer foils by incorporating a single medical port system (9) at a lower end of said circumference weld (7) between said foils,
(b) Providing separate chambers (1,2,3) for the storage of medical products within said circumferential weld (7) by peelable and non-peelable welds (4,5,6),
(c) Leaving unwelded frustoconical interruptions (12,13,14) in one side end of said circumferential weld (7) in an amount corresponding to the number of chambers (1,2,3) suitable for the introduction of filling tubes (22,23,24) in said interruptions (12,13,14),
(d) Introducing said filling tubes (22,23,24) in a liquid tight connection into said interruptions (12,13,14),
(e) Filling said chambers (1,2,3) with said medical products,
(f) Welding said interruptions (12,13,14) to provide a liquid tight bag (10), and
(g) Cutting off those parts of the circumferential weld (7) containing said filling tubes (22,23,24).

6. A flexible multiple chamber bag (10) comprising two foils circumferentially welded two foils and furthermore containing separate chambers peelable and non-peelable welds (4,5,6) within the circumference weld (7) for the separate storing of medical products in separate chambers (1,2,3), containing a hanger (11) extending from the top end of said bag (10) and a single medical port system (9) welded within the lower end of said circumferential weld (7) of said bag (10)
characterized in that
one side end of said bag (10) containing a number of non-welded frustoconical-shaped interruptions (12,13,14) between said two foils, each of said interruptions (12,13,14) respectively being connected to a different chamber (1 or 2 or 3) allowing the temporarily or permanent introduction of an appropriate filling tube (22,23,24) into each of said interruptions (12,13,14) wherein the opening angle from the inner side of the weld to the outer side of the weld of said frustoconical interruptions (12,13,14) is adjusted by welding and encompasses a solid angle of 15° to 60°.
